(19) United States
(12) Patent Application Publication
(10) Pub. No.: US 2024/0209719 A1
(43) Pub. Date: Jun. 27, 2024

(54) ELECTRIC POWERED PUMP DOWN

(71) Applicant: U.S. Well Services, LLC, Houston, TX (US)

(72) Inventors: Jared Oehring, Houston, TX (US); Brandon N. Hinderliter, Houston, TX (US)

(73) Assignee: U.S. Well Services, LLC, Houston, TX (US)

(21) Appl. No.: 18/228,972

(22) Filed: Aug. 1, 2023

Related U.S. Application Data
(63) Continuation of application No. 16/522,043, filed on Jul. 25, 2019, now Pat. No. 11,713,661.
Application No. 16/522,043 is a division of application No. 15/653,028, filed on Jul. 18, 2017, now Pat. No. 10,408,030.
Application No. 15/653,028 is a continuation of application No. 15/291,842, filed on Oct. 12, 2016, now Pat. No. 9,745,840.
Application No. 15/291,842 is a continuation-in-part of application No. 15/202,085, filed on Jul. 5, 2016, now Pat. No. 10,337,308.
Application No. 15/202,085 is a continuation of application No. 13/679,689, filed on Nov. 16, 2012, now Pat. No. 9,410,410.
(60) Provisional application No. 62/242,173, filed on Oct. 15, 2015.

(51) Int. Cl. E21B 43/26; E21B 23/08; E21B 43/267; F01D 15/08; F01D 15/10; F02C 3/22; F04B 17/03; F04B 19/22; F04B 23/04; F04B 47/02; F04B 49/06; F04B 49/20; H02P 23/00

(52) U.S. Cl. CPC E21B 43/2607; E21B 23/08; E21B 43/26; E21B 43/267; F01D 15/08; F01D 15/10; F02C 3/22; F04B 17/03; F04B 19/22; F04B 23/04; F04B 47/02; F04B 49/065; F04B 49/20; H02P 23/00; F05D 2220/32

(57) ABSTRACT

A method of operations in a subterranean formation, including driving a pump with an electrically powered motor to pressurize fluid, inserting a tool into a wellbore that intersects the formation, and directing the pressurized fluid into the wellbore above the tool to push the tool into the wellbore.

### CROSS REFERENCE TO RELATED APPLICATIONS

This application is a continuation of U.S. patent application Ser. No. 16/522,043, filed Jul. 25, 2019, which issued as U.S. Pat. No. 11,713,661 on Aug. 1, 2023, which is a divisional of U.S. patent application Ser. No. 15/653,028, filed Jul. 18, 2017, which issued as U.S. Pat. No. 10,408,030 on Sep. 10, 2019, which is a continuation of U.S. patent application Ser. No. 15/291,842, filed Oct. 12, 2016, which issued as U.S. Pat. No. 9,745,840 on Aug. 29, 2017, and claims priority to and the benefit of U.S. Provisional Application Ser. No. 62/242,173, filed Oct. 15, 2015, and is a continuation-in-part of, and claims priority to and the benefit of U.S. patent application Ser. No. 15/202,085, filed Jul. 5, 2016, which issued as U.S. Pat. No. 10,337,308 on Jul. 2, 2019, and which claims priority to and the benefit of U.S. patent application Ser. No. 13/679,689, filed Nov. 16, 2012, which issued as U.S. Pat. No. 9,410,410 on Aug. 9, 2016; the full disclosures of which are hereby incorporated by reference herein for all intents and purposes.

### BACKGROUND OF THE INVENTION

### 1. Field of Invention

The present disclosure relates to operations in a subterranean formations. In particular, the present disclosure relates to a system that uses fluid pressurized by electrically powered pumps for fracturing and for pump down operations.

### 2. Description of Prior Art

Hydraulic fracturing is a technique used to stimulate production from some hydrocarbon producing wells. The technique usually involves injecting fluid into a wellbore at a pressure sufficient to generate fissures in the formation surrounding the wellbore. Typically the pressurized fluid is injected into a portion of the wellbore that is pressure isolated from the remaining length of the wellbore so that fracturing is limited to a designated portion of the formation. The fracturing fluid slurry, whose primary component is usually water, includes proppant (such as sand or ceramic) that migrate into the fractures with the fracturing fluid slurry and remain to prop open the fractures after pressure is no longer applied to the wellbore. A primary fluid for the slurry other than water, such as nitrogen, carbon dioxide, foam (nitrogen and water), diesel, or other fluids is sometimes used as the primary component instead of water. Typically hydraulic fracturing fleets include a data van unit, blender unit, hydration unit, chemical additive unit, hydraulic fracturing pump unit, sand equipment, and other equipment.

Traditionally, the fracturing fluid slurry has been pressurized on surface by high pressure pumps powered by diesel engines. To produce the pressures required for hydraulic fracturing, the pumps and associated engines have substantial volume and mass. Heavy duty trailers, skids, or trucks are required for transporting the large and heavy pumps and engines to sites where wellbores are being fractured. Each hydraulic fracturing pump is usually composed of a power end and a fluid end. The hydraulic fracturing pump also generally contains seats, valves, a spring, and keepers internally. These parts allow the hydraulic fracturing pump to draw in low pressure fluid slurry (approximately 100 psi) and discharge the same fluid slurry at high pressures (over 10,000 psi). Recently electrical motors controlled by variable frequency drives have been introduced to replace the diesel engines and transmission, which greatly reduces the noise, emissions, and vibrations generated by the equipment during operation, as well as its size footprint.

On each separate unit, a closed circuit hydraulic fluid system is often used for operating auxiliary portions of each type of equipment. These auxiliary components may include dry or liquid chemical pumps, augers, cooling fans, fluid pumps, valves, actuators, greasers, mechanical lubrication, mechanical cooling, mixing paddles, landing gear, and other needed or desired components. This hydraulic fluid system is typically separate and independent of the main hydraulic fracturing fluid slurry that is being pumped into the wellbore.

### SUMMARY OF THE INVENTION

Certain embodiments of the present technology provide a method of operations in a subterranean formation. The method includes driving a pump with an electrically powered motor to pressurize fluid, inserting a tool into a wellbore that intersects the formation, and directing the pressurized fluid into the wellbore above the tool to push the tool into the wellbore. In some embodiments, the method can further include urging the tool into the wellbore with the pressurized fluid until the tool reaches a predetermined location in the formation. In addition, the tool can be a perforating gun.

According to some embodiments, the wellbore can include a first wellbore, wherein the pressurized fluid is simultaneously directed to a second wellbore that also intersects the subterranean formation. Hydraulic fracturing can be performed in the second wellbore. Furthermore, the pump can include a first pump and a second pump, wherein fluid pressurized by the first pump is directed into the first wellbore to push the tool into the first wellbore, and fluid pressurized by the second pump is directed into the second wellbore to use in hydraulic fracturing.

Additional embodiments can include pressurizing fluid with an electric blender to form a boost fluid, directing the boost fluid to the pump. In addition, the electricity that powers the motor can be generated with a generator that is proximate the electric motor, and a wireline system can be powered by the electricity.

Alternate embodiments of the present technology can include a method of operations in a subterranean formation, including generating electricity, energizing electric motors with the electricity, driving a fracturing pump with at least one of the electric motors, and driving a pump down pump with at least one of the electric motors. In certain embodiments, the electricity can be generated by a turbine generator, and the method can include powering a sand conveyer and hydration unit with the electricity.

In some embodiments, the method can further include using a first fluid pressurized by the fracturing pump to fracture the formation, and using a second fluid that is pressurized by the pump down pump in a pump down operation. In addition, the first fluid can be directed to a first wellbore that intersects the formation, and the second fluid can be directed to a second wellbore that intersects the formation.

Yet another embodiment of the present technology includes system for use in a subterranean formation operation. The system includes a pump down pump in communication with a first wellbore that intersects the formation, and that pressurizes fluid in the first wellbore, an electric motor that drives the pump down pump, and a tool positioned in the wellbore below at least a portion of the fluid pressurized by the pump down pump, and that is pushed toward the bottom of the wellbore by the fluid. Certain embodiments of the system can also include a hydraulic fracturing pump in communication with a second wellbore that intersects the formation, and that pressurizes fluid in the second wellbore, and the electric motor that drives the hydraulic fracturing pump.

According to some embodiments, the electric motor can be a first electric motor and a second electric motor, the first electric motor driving the pump down pump, and the second electric motor driving the hydraulic fracturing pump. In addition, the system can further include gas powered turbine generators, and a wireline system that is in electrical communication with the turbine generators.

### BRIEF DESCRIPTION OF DRAWINGS

Some of the features and benefits of the present invention having been stated, others will become apparent as the description proceeds when taken in conjunction with the accompanying drawings, in which:

FIGS. 1A and 1B are schematic examples of a system for use in fracturing and pump down operations.

FIG. 2 is a plan schematic view of an alternate example of the system of FIG. 1.

FIG. 3 is a plan schematic view of an example of an electrically powered pump down system.

FIG. 4 is a perspective view of an example of a pump system for use with the hydraulic fracturing system of FIGS. 1A and 1B.

FIG. 5 is a perspective view of an example of a blender unit for use with the system of FIGS. 1A and 1B.

FIGS. 6 and 7 are plan schematic views of alternate examples of an electrically powered pump down system.

FIG. 8 is a perspective view of an example of an auxiliary unit for use with the system of FIGS. 1A, 1B, and 5.

While the invention will be described in connection with the preferred embodiments, it will be understood that it is not intended to limit the invention to that embodiment. On the contrary, it is intended to cover all alternatives, modifications, and equivalents, as may be included within the spirit and scope of the invention as defined by the appended claims.

### DETAILED DESCRIPTION OF INVENTION

The method and system of the present disclosure will now be described more fully hereinafter with reference to the accompanying drawings in which embodiments are shown. The method and system of the present disclosure may be in many different forms and should not be construed as limited to the illustrated embodiments set forth herein; rather, these embodiments are provided so that this disclosure will be thorough and complete, and will fully convey its scope to those skilled in the art. Like numbers refer to like elements throughout. In an embodiment, usage of the term “about” includes +/−5% of the cited magnitude. In an embodiment, usage of the term “substantially” includes +/−5% of the cited magnitude.

It is to be further understood that the scope of the present disclosure is not limited to the exact details of construction, operation, exact materials, or embodiments shown and described, as modifications and equivalents will be apparent to one skilled in the art. In the drawings and specification, there have been disclosed illustrative embodiments and, although specific terms are employed, they are used in a generic and descriptive sense only and not for the purpose of limitation.

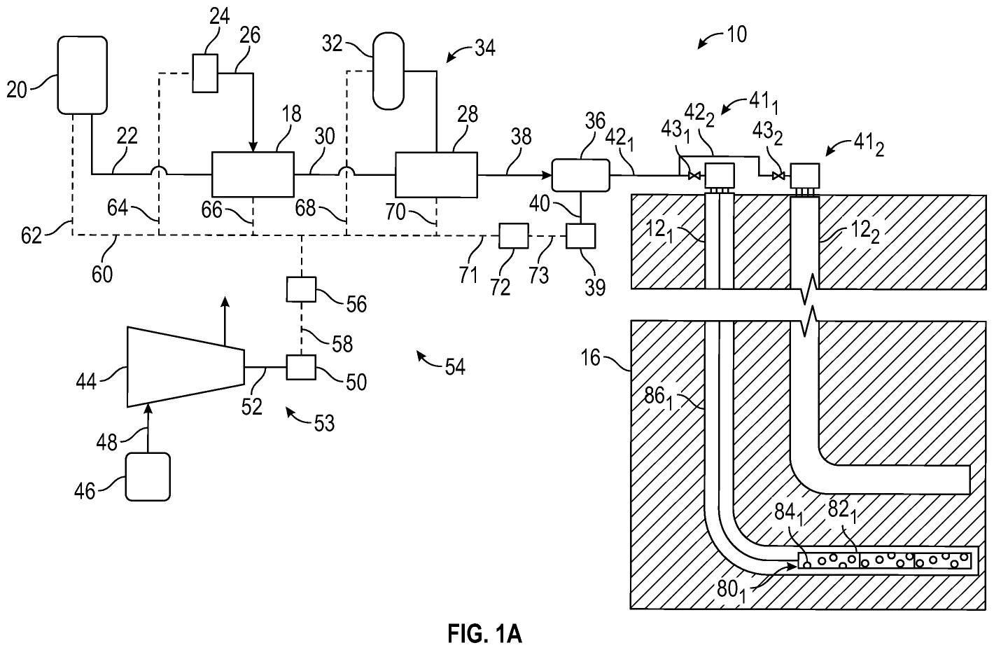

FIG. 1A is a schematic example of a system 10 that is used for providing pressurized fluid to wellbores 121, 122 shown intersecting a subterranean formation 16. As will be described in more detail below, the pressurized fluid can be used in fracturing and/or pump down operations in the wellbores 121, 122. Included with the system 10 is a hydration unit 18 that receives fluid from a fluid source 20 via line 22, and also selectively receives additives from an additive source 24 via line 26. Additive source 24 can be separate from the hydration unit 18 as a stand-alone unit, or can be included as part of the same unit as the hydration unit 18. The fluid, which in one example is water, is mixed inside of the hydration unit 18 with the additives. In an embodiment, the fluid and additives are mixed over a period of time to allow for uniform distribution of the additives within the fluid. In the example of FIG. 1A, the fluid and additive mixture is transferred to a blender unit 28 via line 30. A proppant source 32 contains proppant, which is delivered to the blender unit 28 as represented by line 34, where line 34 can be a conveyer. Inside the blender unit 28, the proppant and fluid/additive mixture are combined to form a slurry, which is then transferred to a pump assembly 36 via line 38; thus fluid in line 38 includes the discharge of blender unit 28, which is the suction (or boost) for the pump assembly 36. Blender unit 28 can have an onboard chemical additive system, such as with chemical pumps and augers. Optionally, additive source 24 can provide chemicals to blender unit 28; or a separate and standalone chemical additive system (not shown) can be provided for delivering chemicals to the blender unit 28. In an example, the pressure of the slurry in line 38 ranges from around 80 psi to around 100 psi. The pressure of the slurry can be increased up to around 15,000 psi by pump assembly 36. A motor 39, which connects to pump assembly 36 via connection 40, drives pump assembly 36 so that it can pressurize the slurry.

After being discharged from pump assembly 36, slurry is injected into a wellhead assembly 411, 412; discharge piping 421, 422 connects discharge of pump assembly 36 with wellhead assembly 411, 412 and provides a conduit for the slurry between the pump assembly 36 and the wellhead assembly 411, 412. In an alternative, hoses or other connections can be used to provide a conduit for the slurry between the pump assembly 36 and the wellhead assembly 411, 412. Optionally, any type of fluid can be pressurized by the pump assembly 36 to form injection fluid that is then pumped into the wellbores 121, 122, and is not limited to fluids having chemicals or proppant. As detailed below, fluid from pump assembly 36 can be used for fracturing the formation 16, for pump down operations in wellbores 121, 122. Examples exist wherein the system 10 includes multiple pump assemblies 36, and multiple motors 39 for driving the multiple fracturing pump assemblies 36. Valves 431, 432, are shown provided respectively on lines 421, 422 for selectively allowing flow into the wellhead assemblies 411, 412.

An example of a turbine 44 is provided in the example of FIG. 1A and which receives a combustible fuel from a fuel source 46 via a feed line 48. In one example, the combustible fuel is natural gas, and the fuel source 46 can be a container of natural gas, a pipeline, or a well (not shown) proximate the turbine 44. Combustion of the fuel in the turbine 44 in turn powers a generator 50 that produces electricity. Shaft 52 connects generator 50 to turbine 44. The combination of the turbine 44, generator 50, and shaft 52 define a turbine generator 53. In another example, gearing can also be used to connect the turbine 44 and generator 50.

An example of a micro-grid 54 is further illustrated in FIG. 1A, which distributes electricity generated by the turbine generator 53. Included with the micro-grid 54 is a transformer 56 for stepping down voltage of the electricity generated by the generator 50 to a voltage more compatible for use by electrical powered devices in the system 10. In another example, the power generated by the turbine generator and the power utilized by the electrical powered devices in the system 10 are of the same voltage, such as 4160 V so that main power transformers are not needed. In one embodiment, multiple 3500 kVA dry cast coil transformers are utilized. Electricity generated in generator 50 is conveyed to transformer 56 via line 58. In one example, transformer 56 steps the voltage down from 13.8 kV to around 600 V. Other stepped down voltages can include 4,160 V, 480 V, or other voltages. The output or low voltage side of the transformer 56 connects to a power bus 60, lines 62, 64, 66, 68, 70, and 71 connect to power bus 60 and deliver electricity to electrically powered end users in the system 10. More specifically, line 62 connects fluid source 20 to bus 60, line 64 connects additive source 24 to bus 60, line 66 connects hydration unit 18 to bus 60, line 68 connects proppant source 32 to bus 60, line 70 connects blender unit 28 to bus 60, and line 71 connects bus 60 to a variable frequency drive (“VFD”) 72. Line 73 connects VFD 72 to motor 39. In one example, VFD 72 selectively provides electrical power to motor 39 via line 73, and can be used to control operation of motor 39, and thus also operation of pump 36.

In an example, additive source 24 contains ten or more chemical pumps for supplementing the existing chemical pumps on the hydration unit 18 and blender unit 28. Chemicals from the additive source 24 can be delivered via lines 26 to either the hydration unit 18 and/or the blender unit 28. In one embodiment, the elements of the system 10 are mobile and can be readily transported to a wellsite adjacent the wellbore 12, such as on trailers or other platforms equipped with wheels or tracks.

Still referring to FIG. 1A, a pump down operation is shown being performed in wellbore 12₁ and wherein a perforating string 80₁ is being pumped down within wellbore 121 by pressurized fluid from the pump system 36. Thus in this example, fluid being discharged from pump system 36 is handled within discharge piping 42₁ and into wellhead assembly 41₁ where it is used to urge the perforating string 80₁ deeper into wellbore 12₁. The example of the perforating string 80₁ includes perforating guns 821 stacked in series and coaxial with one another. Each of the perforating guns 82₁ include a number of shaped charges 84₁ that when detonated create perforations (not shown) within formation 16. In addition, the perforating guns typically may include plugs, to isolate the guns from certain portions of the well, such as portions down hole from the guns. As will be described below, the perforations provide a starting point for fractures to be formed within formation 16 by introduction of high pressure fluid within wellbore 12₁. Each of wellbores 12₁, 12₂ are shown having vertical, deviated and horizontal sections; however, wellbores 12₁, 12₂ can each be substantially vertical, or one can be vertical and the other have deviated and horizontal portions. Further illustrated in FIG. 1A is a wireline 86₁ which depends downward from the wellhead assembly 41₁ and to perforating string 80₁. Wireline 86₁ can be used to deploy and retrieve perforating string 80₁ from within wellbore 12₁. Moreover, signals for initiating detonation of the shaped charges 84₁ can come via wireline 86₁ and from surface.

FIG. 1B illustrates an example where pressurized fluid from pump system 36 has been introduced into wellbore 12₁ and so that perforations 90 are formed in formation 16 and that project radially outward from wellbore 12₁. As indicated above, the perforations 90 created by shaped charges 84₁ (FIG. 1A) provide initiation points within formation 16 from which fluid can propagate into formation 16 to form fractures.

An advantage of the system 10 is that in situations when wellbores 12₁, 122 are proximate one another, the pump system 36 can provide pressurized fluid to each of these wellbores 12₁, 12₂, and for different purposes. As illustrated in FIG. 1B, the step of hydraulic fracturing is taking place in wellbore 12₁, while substantially simultaneously a pump down operation is occurring in wellbore 12₂. More specifically, a perforating string 80₂, similar in construction to the perforating string 80₁ of FIG. 1A, is being deployed within wellbore 12₂. Also, perforating string 80₂ includes coaxially coupled perforating guns 82₂ and which each include a number of shaped charges 84₂ for creating perforations (not shown) within formation 16. Deployment, retrieval, and signal communication between surface and perforating string 80₂ can be accomplished via wireline 86₂ shown inserted within wellbore 12₂.

In one example of operation, the system 10 can be used to selectively provide the pressurized fluid to the adjacent wellbores 12₁, 12₂ so that what is referred to in the industry as a zipper operation can take place. A zipper operation is where adjacent wellbores are perforated and fractured along an alternating sequence. Moreover, the zipper operation is done sequentially so that the different operations can be performed on different wells on the same well site, which speeds up completion activities. As illustrated in the figures described below, separate pumping systems can provide the fluid for the fracturing and the pump down operations.

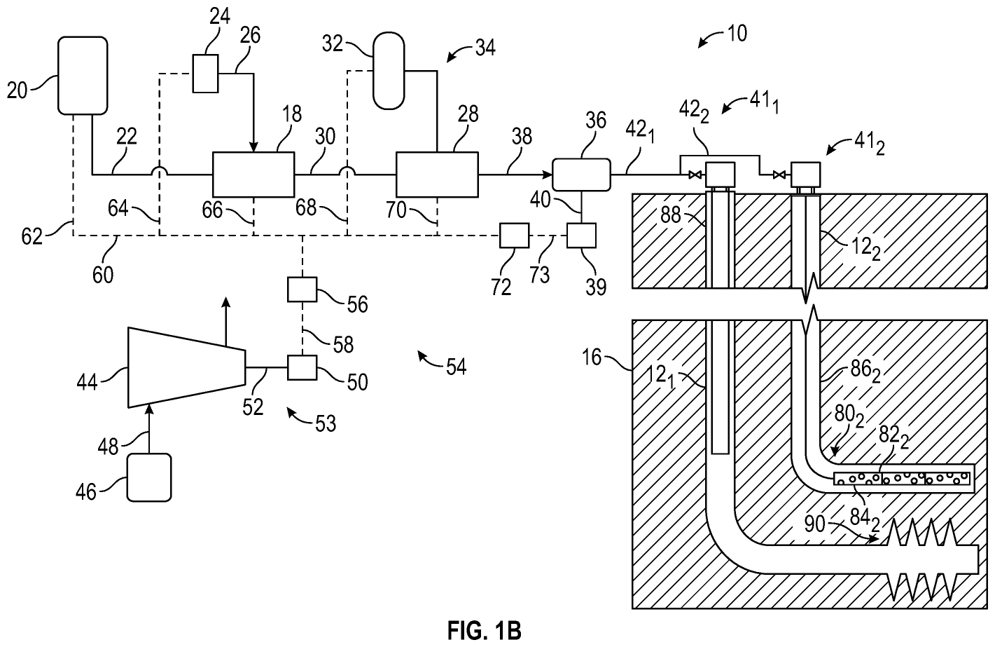

Shown in FIG. 2 is a schematic plan view of one example of system 10A where turbine generators 53A_{1,2} and 53A_{3,4} respectively generate electricity that is delivered to switch gear 92A₁ and 92A₂, that in turn deliver the output electricity to transformers 56A₁₋ₙ and auxiliary units 94A_{1,2}. Auxiliary unit 94A₁ transmits electricity to sand equipment 32A, hydration unit 18A, frac blender 28A, and a frac data van 95A. In one example, frac data van 95A is an enclosed vehicle that provides controls and monitoring equipment for use in controlling and monitoring the fracturing system. Electricity from transformers 56A₁₋ₙ, which is received from switch gear 92A_{1,2} is delivered at a designated voltage to fracturing pumps 36A₁₋ₙ, wherein fracturing pumps 36A₁₋ₙ are dedicated to pressurizing fluid for use in fracturing operations. Also from transformers 56A₁₋ₙ electricity is transmitted to pump down units 96A₁₋ₙ that are used for pressurizing fluid used in pump down operations as described above. It should be pointed out, that the pump down operations are not limited to disposing perforating strings within wellbores, but can include any other type of equipment that is to be positioned at a designated depth within a wellbore.

Further illustrated in FIG. 2 is that auxiliary 94A₂ has an output that delivers electricity to a blender 98A for use in pump down and a data van 100A that is also used for pump down. The separate data van 100A and blender 98A can be used, for example, during zipper fracturing operations, but are not required for stack fracturing operations. This is because during stack fracturing operations, only one operation is occurring at a time, so the frac datavan 95A and frac blender 28A can be used for all operations. Further illustrated in FIG. 2 is that the power from auxiliary 94A₂ transmits to an optional transformer 102A, which can be used to step down electricity for use by a crane 104A and wireline system 106A if the crane 104A and wireline system 106A require a lower voltage than the fracturing equipment. Examples exist where crane 104A and wireline system 106A provide the hoisting and signal capabilities for the wireline 86_{1,2} of FIGS. 1A and 1B. Moreover, wireline system 106A can include a wireline truck having a spool of wireline as well as controllers and initiation hardware for sending communication and initiation signals down the wireline 86_{1,2}.

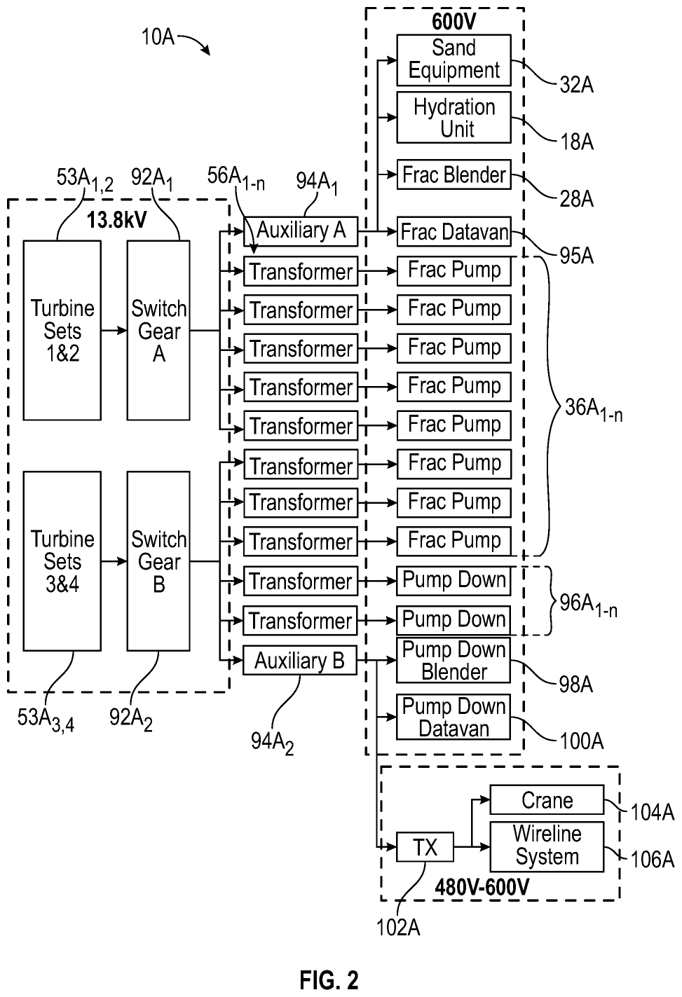

FIG. 3 shows, in a schematic plan view, one example of a pump down system 108B that pressurizes fluid for use in a pump down operation. In this example, a turbine set 53B is used for generating electricity, and that like the other turbine sets described herein is powered by combustion of natural gas that then drives a generator to produce electricity. The electricity is delivered to switch gear 92B and which has an output shown in communication with transformers 56B_{1-N} and auxiliary 94B. One of transformers 56B_{1-N} delivers electricity to other equipment 110B which can include, for example, glycol heaters, light plants, a company man trailer, water transfer pumps, a crane, wellsite tools, etc. Others of the transformers 56B₁₋ₙ have outputs at designated voltages (e.g., 600V, 480V, or step up transformers) that communicate with pump down pumps 96B₁₋ₙ that are schematically illustrated provided on trailers and within the pump down system 108B. Further included with the pump down system 108B is a blender 98B for blending the fluid that is then to be pressurized by the pump down pumps, and a data van 100B which provides a location for personnel to control and monitor equipment within the pump down system 108B. In this example, electricity is generated specifically for the pump down pumps and is not diverted from that being used to drive pumps used for fracturing. Additionally, the fluid being pressurized is from the pump down pumps and not from a fracturing pump.

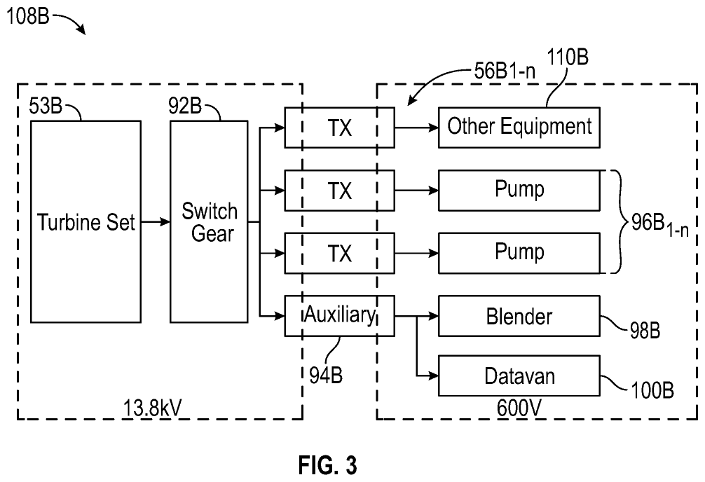

Provided in a perspective view in FIG. 4 is one example of a pump system 36C, which can be used either for pump down operations or for fracturing operations. In the illustrated example, pumps 112C_{1,2} are shown mounted on a trailer 114C so that the pumps 112C_{1,2} can be readily transported to different locations for onsite operation. Additionally, a VFD housing 116C is also mounted on trailer 114C and in which equipment such as VFDs for pumps, isolation breakers, and a motor control center can be situated during operation of pumps 112C_{1,2}. The motor control cabinet can be a breaker cabinet that contains breakers for smaller motors such as blower motors, lube motors, and fan motors.

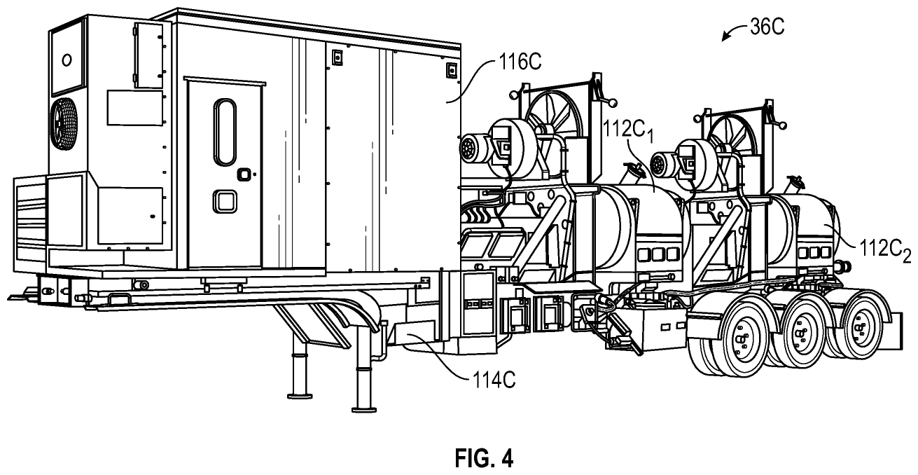

Shown in FIG. 5 is an example of a blender unit 28D shown in a perspective view. Here, blender unit 28D is shown including a hopper 118D and auger assembly 119D, and wherein the hopper 118D receives sand or other proppant from a sand source, such as a conveyor (shown in FIG. 1). Auger assembly 119D, which is an elongated section having barrel and auger screws rotatably disposed within, urge the sand upward. Hopper 118D and auger assembly 119D are mounted on a trailer 120D and adjacent a mixing tub 122D, which is typically an open top tub where sand, water, and chemicals are mixed together to form a slurry that is then provided to pumps where the fluid is pressurized. The slurry that flows to pumps is directed through a manifold 124D that mounts on a lower end of trailer 120D. Also included with the blender unit 28D is a control room 126D which communicates with the datavan, houses operations personnel, and provides monitoring and controls devices for operating and monitoring of the blender unit 28D.

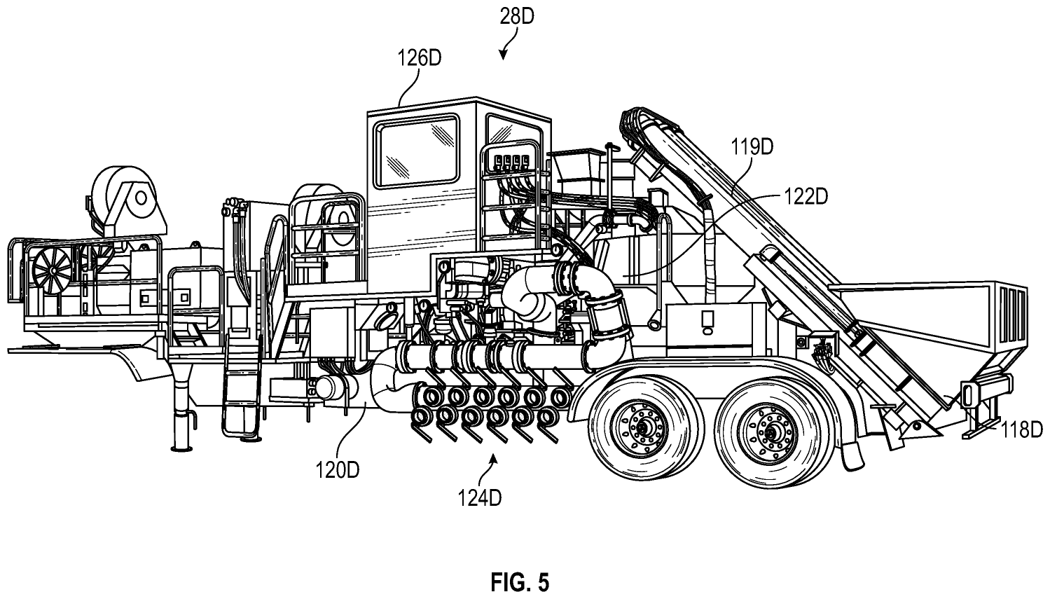

An alternate embodiment of a pump down system 108E is shown in a plan schematic view in FIG. 6, where turbine set 53E with a gas powered turbine generator generates electricity that is then delivered to a switch gear 92E. Output from switch gear 92E is delivered to transformers 56E_{1,2} that in turn provide electrical power to pump down pumps 96E₁₋₂ shown mounted on trailers. Electricity from switch gear 92E is also directed to an auxiliary unit 94E that supplies electricity to both a blender 98E and data van 100E. Included within blender 98E is a pump (not shown) that in some embodiments pressurizes fluid to a boost pressure that is then delivered to the pump down pumps 96E₁₋₂. In an example, the blender 98E pressurizes the fluid in a range from about 70 psi to about 120 psi. Further, within electric blender 98E chemical additives can be added to the fluid that is then delivered to the pump down pumps. Other examples exist, wherein blender for use with a pump down system is a blender that is part of the fracturing system.

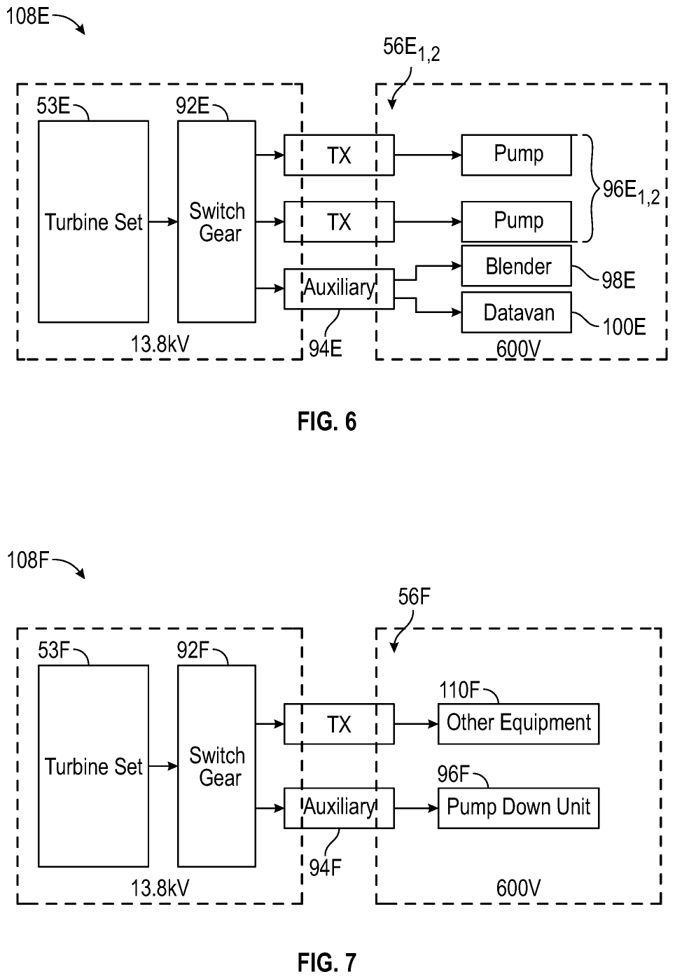

Another alternate example of the pump down system 108F is illustrated in plan schematic view in FIG. 7 and where turbine set 53F, which uses gas-powered turbines to generate electricity, delivers electricity to switch gear 92F. In this example, a transformer 56F receives electricity from switch gear 92F and delivers it to other equipment 110F. Also fed by switch gear 92F is auxiliary 94F, which in turn provides electrical power to pump down unit 96F that is independent of electrical power for the hydraulic fracturing pumps. In the embodiment of FIG. 7, the pump down unit 96F can include a small boost pump (capable of, for example, up to about 20 barrels per minute (bpm) at 100 psi instead of about 130 bpm for a blender), and a water pump (capable of about 20 bpm at 10,000 psi) to replace the hydraulic fracturing pumps. Thus, the pump down system 108F of FIG. 7 is capable of operating separately from the rest of the fracking system, or from the hydraulic fracturing pumps. This flexibility allows use of the electric powered pump down system with any type of hydraulic fracturing system, whether such system is powered by electricity, diesel, or otherwise. This is also true of the embodiments shown in FIGS. 3 and 6.

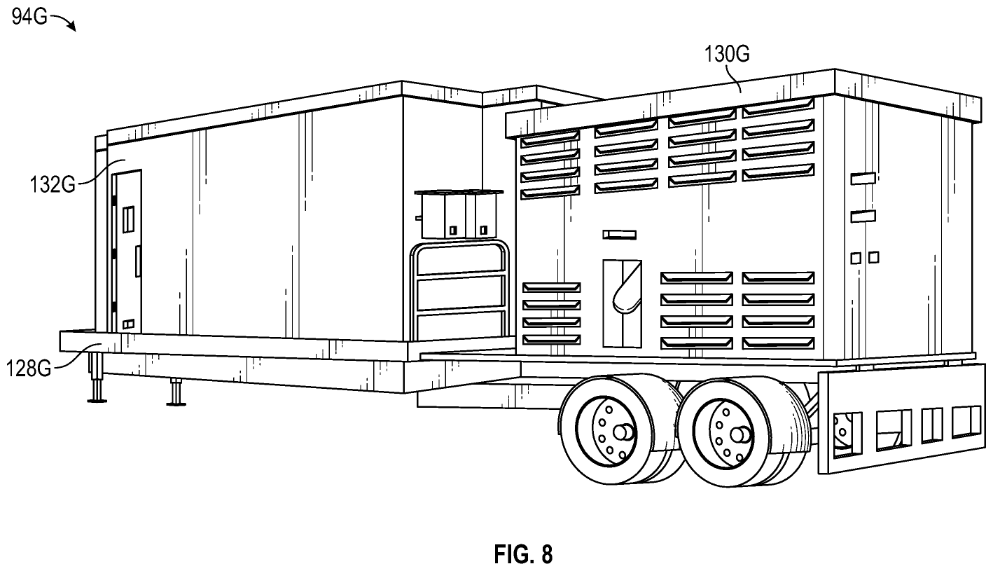

FIG. 8 shows in a side perspective view an example of an auxiliary unit 94G and which includes a trailer 128G and on which a transformer 130G and a VFD house 132G are mounted. The VFD house 132G and transformer 130G can be used to power and control the desired equipment, such as, for example, the blender, the hydration unit, the conveyor, and/or the datavan. The VFD house 132G can also contain soft starters for, large non speed controlled motors, smaller blower motors and radiator fans for cooling. Power can be provided from turbines, to a switchgear, then to the auxiliary unit 94G. The transformer 130G can be used, for example, to convert power from 13.8 kV to 600V to provide power to the VFD house. The blender did not have room to contain its own VFD therefore the Auxiliary Trailer was created to serve this purpose. Each hydraulic fracturing site can benefit from the use of a single auxiliary unit 94G or multiple auxiliary units 94G depending on the individual needs and circumstances at the site.

Use of auxiliary units 94G is advantageous because each separate auxiliary unit 94G provides a separate power grid, thereby creating multiple power centers, which in turn allows for greater flexibility in the positioning of equipment at a site, and creates redundancy in the operations. The use of auxiliary units 94G also helps with power cable management, providing multiple different cable routing for the equipment.

The present invention described herein, therefore, is well adapted to carry out the objects and attain the ends and advantages mentioned, as well as others inherent therein. While a presently preferred embodiment of the invention has been given for purposes of disclosure, numerous changes exist in the details of procedures for accomplishing the desired results. These and other similar modifications will readily suggest themselves to those skilled in the art, and are intended to be encompassed within the spirit of the present invention disclosed herein and the scope of the appended claims.

What is claimed is:

1. A system for use in a subterranean formation operation comprising:
a first wellbore extending into the subterranean formation;
a second wellbore extending into the subterranean formation, the second wellbore being proximate the first wellbore;
an electrically driven pump down pump is communication with the first wellbore, the pump down pump pressurizing fluid in the first wellbore to drive a tool positioned in the first wellbore downstream to a predetermined location in the first wellbore; and
a hydraulic fracturing pump in communication with the second wellbore, the hydraulic fracturing pump pressurizing fluid in the second wellbore to conduct fracturing operations.
